(19) United States
(12) Patent Application Publication
(10) Pub. No.: US 2012/0298584 A1
(43) Pub. Date: Nov. 29, 2012

(54) LIQUID RECOVERY AND PURIFICATION IN BIOMASS PRETREATMENT PROCESS

(75) Inventors: Glenn Lipscomb, Perrysburg, OH (US); Sasidhar Varanasi, Toledo, OH (US)

(73) Assignee: UNIVERSITY OF TOLEDO, TOLEDO, OH (US)

(21) Appl. No.: 13/508,927

(22) PCT Filed: Nov. 9, 2010
(86) PCT No.: PCT/US10/56076

§ 371 Date: Aug. 17, 2012

Related U.S. Application Data
(60) Provisional application No. 61/259,537, filed on Nov. 9, 2009.

(51) Int. Cl. B01D 61/14; C25B 7/00; B01D 43/00; B01D 61/02; B82Y 99/00; B82Y 30/00

(52) U.S. Cl. 210/652; 210/806; 210/650; 204/518; 977/902; 977/781

(57) ABSTRACT

The invention includes a process for recovering the liquids used in pretreatment of biomass for production of bio-fuels and other biomass based products. Liquid recovery and purifications minimizes waste production and enhances process profitability.

### SUMMARY OF THE INVENTION

The invention includes a process for recovering the liquids used in pretreatment of biomass for production of biofuels and other biomass based products. Liquid recovery and purification minimizes waste production and enhances process profitability.

### DETAILED DESCRIPTION OF PREFERRED EMBODIMENTS

Disclosed herein is a process for recovering and purifying the liquids used for biomass pretreatment. Pretreatment is critical to increasing rates of saccharification before sugar conversion to bioproducts.

A wide range of materials have been utilized for pretreatment including acids (e.g., sulfuric acid), ammonia, carbon dioxide, organic solvents, and ionic liquids. Pretreatment opens the complex, recalcitrant structure of ligno-cellulosic materials by removing the lignin and hemi-cellulose layers that surround the crystalline cellulosic core. Pretreatment also opens the crystalline cellulose structure. After pretreatment, enzymatic saccharification occurs at dramatically higher rates which reduces processing times and equipment sizes.

To meet the targets for bioethanol production, large quantities of biomass must be processed. This will require large volumes of pretreatment chemicals. Process economics require special attention to the recovery and disposal of these materials. Ideally, pretreatment chemicals would be recovered, purified, and recycled thereby avoiding waste disposal. Additionally, water is used as a solvent throughout the process. Water usage is greater than pretreatment chemical usage so processes that permit water recycle are equally desirable.

Ionic liquids (ILs) offer a rapid, efficient solvent for pretreating biomass for saccharification. Exemplary ILs may be found, for example, in U.S. Patent Application Publication No. 20090011473 to Varanasi et al. The ILs may be categorized based on the structure of the cations or anions. Many of these ILs are effective in biomass pretreatment.

Recovery and recycle of pretreatment chemicals and water will require processes that can remove insoluble particulate matter and separate liquid mixtures of neutral species with a wide range of polarities. Membrane separation processes may be used effectively for these separations and in combination offer the potential for recycle of water and pretreatment chemicals. The proposed process incorporating membrane technology is described next.

### Particulate Removal

Membrane filtration may be used to remove particulate matter ranging in size from microns to nanometers. Microfiltration, ultrafiltration, and nanofiltration processes remove progressively smaller material. A combination of these processes may be used to remove suspended particulate matter from spent processes streams prior to further purification and recycle.

Alternatively, electrodialysis processes permit removal of particulate matter from ionic pretreatment chemicals such as ILs. The ionic species pass through a series of cation and anion exchange membranes under the influence of an applied electric potential. In comparison to membrane filtration, electrodialysis may allow recovery of a greater percentage of the pretreatment chemical as we have demonstrated.

### Liquid Separations

The pretreatment chemicals commonly are mixed with other solvents in the pretreatment process. Water is used primarily as the solvent during the pretreatment process but other fluids may be used including low molecular weight alcohols.

Thermal processes that separate fluids based on differences in equilibrium vapor pressure are used widely in the chemical process industry. Distillation effectively separates species with large differences in vapor pressure. However, it is less effective for mixtures of species with small difference in boiling points, form azeotropes, or show highly non-ideal solution behavior.

For these mixtures membrane separation processes based on differences in chemical potential offer unique advantages. The membrane selectively permeates one of the species to increases its concentration in the permeate. Membrane processes are not limited by equilibrium behavior and can be driven by using a sweep that increases the chemical potential driving force for transport across the membrane. Membrane modules are designed to provide efficient contacting between the feed and sweep.

Reverse osmosis may be used to concentrate pretreatment chemicals by selectively permeating water or other solvents. For example, reverse osmosis membranes possess a pore and chemical structure that inhibit the transport of IL ions relative to the solvent. However, our initial work indicates reverse osmosis membranes are not sufficiently selective to the solvent to permit high levels of IL recovery.

Membrane dehydration is an alternative for the recovery of pretreatment chemicals. In membrane dehydration processes, a sweep contacts a liquid feed across a membrane. The membrane permits selective transport of one component of the liquid mixture to the sweep.

Membrane dehydration is an attractive process for the recovery of IL from mixtures with water or other process solvents since ILs are non-volatile and cannot be removed by vaporization into the sweep. Experiments using aqueous IL mixtures confirm this.

Data obtained for water removal using an Osmonics RO AG membrane with a liquid feed of 30 ml/min and an air sweep feed rate of 15 L/min at a Temperature of 40° C. are given in Table 1. The data are presented as water removal rate as a function of IL concentration.

TABLE 1

| IL Concentration | Water Flux |
|---|---|
| (%) | (kg/hr/m²) |
| 22.84 | 0.142 |
| 26.07 | 0.138 |
| 33.07 | 0.122 |
| 36.7 | 0.126 |
| 38.97 | 0.119 |
| 47.36 | 0.086 |
| 51.72 | 0.081 |
| 56.54 | 0.065 |
| 57.74 | 0.041 |
| 62.1 | 0.043 |
| 67.54 | 0.032 |
| 70.64 | 0.022 |
| 73.33 | 0.011 |
| 77 | 0.009 |
| 80.9 | 0.000 |

The water flux dropped to near zero at an IL concentration of ˜81%. This limitation arises from the use of compressed air that was not dehumidified. The presence of water vapor in the air sweep inhibits water transport across the membrane.

To remove water vapor a commercial air dehydration membrane was inserted in the line between the compressed air supply and the membrane module used for IL dehydration. Measured water removal rates as a function of IL concentration are reported in Table 2 for the same operating conditions as used to obtain the data in Table 1. However, the data in Table 2 was obtained using an Osmonics RO AK membrane instead of an AG membrane.

TABLE 2

| IL Weight | Water Flux |
|---|---|
| Concentration (%) | (kg/hr/m²) |
| 64.30 | 0.052 |
| 73.01 | 0.030 |
| 75.50 | 0.015 |
| 81.60 | 0.008 |
| 83.50 | 0.006 |
| 85.90 | 0.000 |

Dehydration of the compressed air feed increases the maximum achievable IL concentration to ˜86%.

To further concentrate the IL, the compressed air flow rate through the air dehydration module was reduced. Reducing the flow rate decreases the water concentration of the dried air leaving the module. Data obtained for an air flow rate of 6 L/min are given in Table 3. All other experimental conditions are the same as for the data in Table 2.

TABLE 3

| IL Weight | Water Flux |
|---|---|
| Concentration (%) | (kg/hr/m²) |
| 75.46 | 0.018 |
| 80.18 | 0.013 |
| 83.22 | 0.005 |
| 85.20 | 0.004 |
| 87.70 | 0.000 |

The maximum concentration increased slightly to −88%.

For the viscous IL-water mixtures used, the water concentration in the liquid adjacent to the membrane may decrease significantly due to concentration polarization. Increasing the liquid flow rate reduces concentration polarization and increases the water concentration at the membrane surface that drives transport across the membrane.

Table 4 indicates how water removal rates depend on IL concentration when the liquid flow rate is increased to 60 ml/min; all other experiment conditions are identical to those used to obtain the data in Table 2.

TABLE 4

| IL Weight | Water Flux |
|---|---|
| Concentration (%) | (kg/hr/m²) |
| 88.92 | 0.0044 |
| 93.70 | 0.0043 |
| 94.68 | 0.0041 |
| 96.42 | 0.0031 |
| 96.86 | 0.0000 |

Increasing the liquid flow rate increases the maximum IL concentration to −97%. Optimization of liquid and gas flow rates may increase water fluxes further. No evidence for IL permeation across the dehydration membranes was found upon examination of the membranes after the dehydration experiments.

Any non-condensable gas may be used as this sweep. For example, helium, nitrogen, and argon may be used. The choice of sweep will depend on process economics.

Membranes for the processes described here may be produced in flat sheet, tubular, or hollow fiber shapes. The membranes may be formed from organic or inorganic materials that provide the required separation characteristics and are stable in the chemical and thermal environment of the process. Incorporation of the membranes in spiral wound or hollow fiber modules permits effective contacting with process streams.

Certain teachings related to liquid recovery and purification in biomass pretreatment processes were disclosed in U.S. Provisional patent application No. 61/259,537, filed Nov. 9, 2009, the disclosure of which is herein incorporated by reference in its entirety.

What is claimed is:

1. A method for recovering and purifying liquids used for biomass pretreatment, said method comprising the steps of:
a. Removing particulate matter from a spent process stream of a biomass pretreatment process; and
b. Separating liquids present in the spent process stream of a biomass pretreatment process.

2. The method of claim 1, wherein membrane filtration is applied to achieve the removal of particulate matter from the spent process stream in step a.

3. The method of claim 2, wherein said membrane filtration comprises microfiltration, ultrafiltration, or nanofiltration, or any combination of any two or all three of these processes.

4. The method of claim 1, wherein electrodialysis is applied to achieve the removal of particulate matter from the spent process stream in step a.

5. The method of claim 1, wherein reverse osmosis is applied to achieve the separation of the liquids present in the spent process stream of a biomass pretreatment process.

6. The method of claim 1, wherein membrane dehydration is applied to achieve the separation of the liquids present in the spent process stream of a biomass pretreatment process.

7. The method of claim 6, wherein said membrane dehydration is carried out with a non-condensable gas.

8. The method of claim 7, wherein said non-condensable gas comprises helium, nitrogen, or argon.

9. The method of claim 2, wherein a membrane used to carry out said membrane filtration is a flat sheet, tubular, or a hollow fiber shape.

10. The method of claim 4, wherein a membrane used to carry out said electrodialysis is a flat sheet, tubular, or a hollow fiber shape.

11. The method of claim 5, wherein a membrane used to carry out said reverse osmosis is a flat sheet, tubular, or a hollow fiber shape.

12. The method of claim 6, wherein a membrane used to carry out said membrane dehydration is a flat sheet, tubular, or a hollow fiber shape.
